(19) United States
(12) Patent Application Publication
(10) Pub. No.: US 2009/0125915 A1
(43) Pub. Date: May 14, 2009

(54) System and method for displaying movable message block

(75) Inventors: Chaucer Chiu, Taipei (TW); Nasara Yue, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 11/979,979

(22) Filed: Nov. 13, 2007

(51) Int. Cl. G06F 3/00

(52) U.S. Cl. 719/314

(57) ABSTRACT

A system and a method for displaying movable message blocks are provided, which are applicable for solving the problem that a user-friendly message block display interface cannot be provided when a user logs in a message website. By means of moving message blocks to be displayed in a first display layer and a second display layer and determining whether received operation identification information and received trigger event are consistent with one of parameters of the message blocks, the message blocks consistent with the operation identification information and the trigger event are moved to the first display layer, and the other message blocks are moved to the second display layer, thereby achieving the efficacies of browsing and operating the message blocks on the message website more conveniently and visually.

### BACKGROUND OF THE INVENTION

1. Field of the Invention

The present invention relates to a system and a method for displaying message blocks, and more particularly to a system and a method for displaying movable message blocks, applicable in a message website for moving the message blocks according to operation identification information and trigger events.

2. Related Art

A message block display system is very common for applications of a personal computer. Some message blocks are displayed regularly, but others are popped up irregularly. These message blocks are displayed at default positions on a computer desktop. A user may drag the message blocks to the default positions or to those positions convenient for reading through using a mouse.

With the popularization of network applications, a message website begins to be applied in the network, i.e., different users in the network may input some message blocks over such a website to communicate with others. However, in the message website, for purpose of conveniently browsing and selecting, the message blocks are generally displayed in a list-style-type interface. As a result, a user can only read the message blocks one by one, as the massage blocks cannot be moved and it cannot input one condition to search desired message blocks and then display the results. As such, the user often spends a lot of time in reading, and what's worse, if the user has to find one from so many message blocks, it becomes much more inconvenient. Hence, it can be known that it is inconvenient in operation to display the message blocks in the list-style-type interface and should be improved.

The message website may display the message blocks through an application of a personal computer, for example. If the system for displaying message blocks runs in a stand-alone operating system environment, whenever the system is activated, the message blocks may stay at the positions where they were at the end of the previous operation, such that it suffers no serious problems. However, in an application environment of message website, i.e., an network operation environment opened to many users and enabling a plurality of computers to operate on line at the same time, if, when the user logs in the system once again, the message blocks are still displayed at the positions where they were when the user logged out the system, the user may find that many unsorted new message blocks are displayed on the message block display interface. The positions of the message blocks after the user logged out are still maintained to be the same when the user logs in once again, but the message blocks are covered by many new message blocks, as a result, a lot of message blocks are closely stacked with one another. As a result, the user has no choice but to move and read them one by one, so as to find his/her own message blocks.

Although displaying message blocks in a message website through a message block display interface of a message block display system may solve the problem that the inconvenience to display message blocks in a list-style-type interface, it is rather inconvenient that the user cannot find his/her own message blocks immediately from so many message blocks and it cannot provide a more convenient operation interface. Accordingly, it has become a problem to be solved how to provide a message block display interface that is used conveniently and is a visual interface consistent with the users' message blocks.

### SUMMARY OF THE INVENTION

In view of the problems of the method for displaying message blocks in a list-style-type interface in a message website in the prior art, the present invention is directed to a system and a method for displaying movable message blocks, which is capable of providing a user-friendly message block interface.

The system for displaying movable message blocks provided by the present invention is applied in a movable message block display interface having a plurality of message blocks, and the system for displaying movable message blocks includes a receiving module, a determination module, and a message block adjustment module.

The method for displaying movable message blocks provided by the present invention is applied in a movable message block display interface having a plurality of message blocks, which includes the following steps: receiving operation identification information; and when it is determined that the operation identification information is consistent with one of the parameters of each of the message blocks, performing the following steps: the message blocks consistent with the operation identification information are moved to a first display layer, and the message blocks inconsistent with the operation identification information are moved to a second display layer. Then, waiting for receiving at least one trigger event, and when a trigger event is received and it is determined that the trigger event is consistent with one of the parameters of each of the message blocks, the following steps are further performed: the message blocks inconsistent with the trigger event are moved from the first display layer to the second display layer; and the message blocks consistent with the trigger event are moved from the second display layer to the first display layer. The first display layer is displayed above the second display layer.

Compared with the technical means of displaying message blocks in a list-style-type interface in a message website, the present invention may achieve the efficacies of making the operations be more convenient and visual through the message block display interface having movable blocks in a message website.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a flow chart of a method for displaying movable message blocks according to the present invention.

FIG. 2 is a block diagram of a system for displaying movable message blocks according to the present invention.

FIG. 3A is a schematic view of a message block display interface according to a first embodiment of the present invention.

FIG. 3B is a schematic view of a message block display interface according to a second embodiment of the present invention.

### DETAILED DESCRIPTION OF THE INVENTION

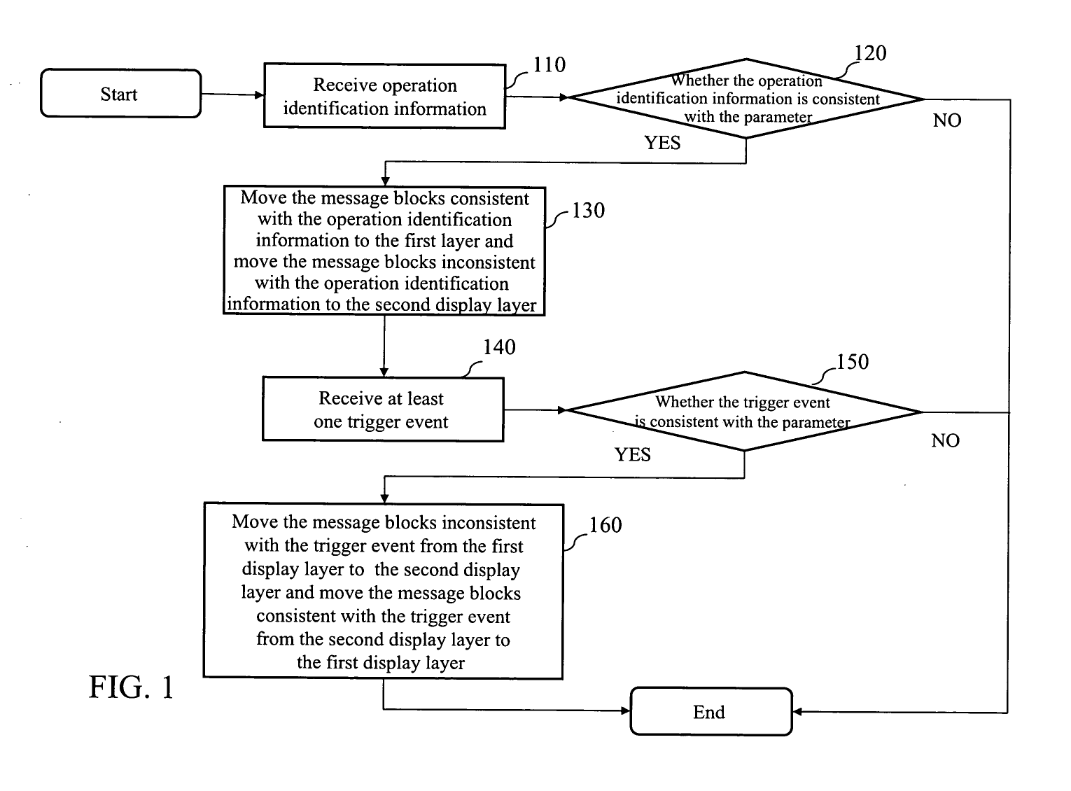

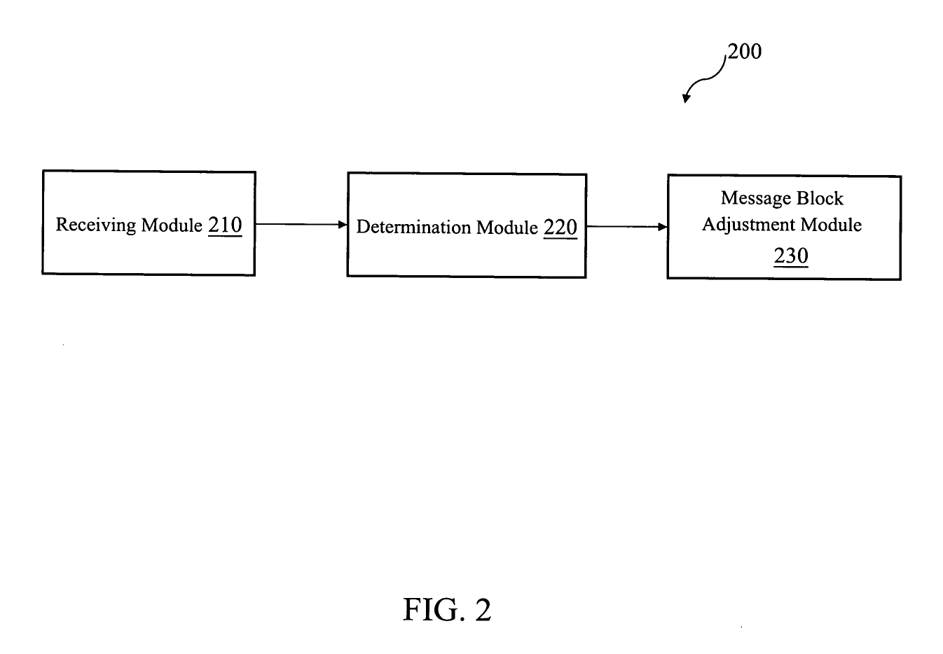

The present invention provides a system and a method for displaying movable message blocks, which will be illustrated as follows with reference to the flow chart of the method in FIG. 1 and the block diagram of the system in FIG. 2.

The present invention is applied in a message block display interface for displaying a plurality of message blocks. For example, in a message board of an MSN message website introduced by Microsoft, the message block mentioned in the present invention refers to a piece of message on the MSN message board. However, in fact, the practical application of the present invention is not limited to any specific message website.

In any message website without applying the present invention, before a user logs in, all message blocks are not displayed in different layers and the message blocks have no mark attributes. Once the present invention is applied, the user will input a user name, a user code, or a user ID as operation identification information when logging in the message website, and at this time, the receiving module 210 receives the operation identification information (Step 110). Then, the operation identification information is received and further transferred to the determination module 220, which determines whether the operation identification information of the user is consistent with one of the parameters of each of the message blocks (Step 120). Each of the message blocks corresponds to a plurality of parameters, including the operation identification information, a time condition, message identification information, and a selection instruction. When the operation identification information of the user is consistent with one of the parameters of each of the message blocks, the determination module 220 informs a message block adjustment module 230. Then, the message block adjustment module 230 is used to move the message block consistent with the operation identification information of the user to a first display layer (Step 130) and to move the message block inconsistent with the operation identification information of the user to a second display layer (Step 130). It should be noted that, the message block on the first display layer is displayed above the message block on the second display layer, thereby forming a message block display interface with the message blocks being displayed in different layers and be moved.

For example, it is assumed that, there are two message blocks in the message website and the corresponding parameters of operation identification information are respectively “Mary” and “Xiao Lin”. When the user inputs the user ID “Mary” as the operation identification information, the receiving module 210 receives the operation identification information (Step 110). Then, in order to move the message block, the determination module 220 determines whether the operation identification information is consistent with the parameter of the operation identification information of each of the message blocks (Step 120). When the parameter of the operation identification information “Mary” of the message block is the same as the received operation identification information “Mary”, the message block adjustment module 230 moves the message block consistent with the operation identification information “Mary” to the first display layer and meanwhile moves the message block with the operation identification information “Xiao Lin” to the second display layer (because the parameter of the operation identification information “Xiao Lin” of the message block is different from the received operation identification information “Mary”) (Step 130).

Then, the receiving module 210 waits for receiving at least one trigger event (Step 140), in which the trigger event includes input information or a selection event. The input information is an input time condition or input message identification information; and the selection event is a selection instruction. For example, the trigger event may be a date (on which the message block is added), the name of a message sender, the code of the message sender, or the ID of the message sender inputted through a keyboard, or the trigger event may indicate a message block selected through using a mouse; and the operation identification information and the message identification information may be set depending upon actual requirements according to any one of the name of the user/message sender, the code of the user/message sender, and the ID of the user/message sender.

When the receiving module 210 receives the trigger event (Step 140), the determination module 220 determines whether the received trigger event is consistent with one of the parameters of each of the message blocks (Step 150). When the trigger event is consistent with one of the parameters of each of the message blocks, the determination module 220 informs the message block adjustment module 230, and then the message block adjustment module 230 moves the message block inconsistent with the trigger event from the first display layer to the second display layer and moves the message block consistent with the trigger event from the second display layer to the first display layer (Step 160). The trigger event may be generated at any time with the user's operation, and when the receiving module 210 receives the trigger event again (Step 140), Steps 150 and 160 are repeated.

The trigger event is further illustrated below. For example, it is assumed that there are two message blocks in a message website corresponding to two parameters, the time conditions “May 8, 2007” and “Jul. 10, 2007” and the message identification information “Mary” and “Xiao Lin”. It is assumed that the parameter of the time condition is a date on which the message block is newly added and the message identification information is the ID of the message sender. When the ID of the message sender “Xiao Lin” input by the user is served as the trigger event, the receiving module 210 receives the trigger event (Step 140). Then, in order to move the message block consistent with the trigger event “Xiao Lin” to the first display layer, the determination module 220 determines whether the received trigger event is consistent with the parameter of the ID of the message sender for each of the message blocks (Step 150), and then the message block adjustment module 230 moves the message block consistent with the ID of the message sender “Xiao Lin” to the first display layer (the parameter of the ID of the message sender “Xiao Lin” for the message block is the same as the trigger event “Xiao Lin”), and moves the message block with the user ID “Mary” to the second display layer (the parameter of the ID of the message sender “Mary” for the message block is different from the trigger event “Xiao Lin”) (Step 160). Likewise, when the user once again inputs the time condition “May 8, 2007” as the trigger event and the receiving module 210 receives the trigger event again (Step 140), and then, Steps 150 and 160 are repeated.

In the present invention, all message blocks are displayed in two layers. The message blocks consistent with the operation identification information or the trigger event are displayed on the first display layer, and the other message blocks are displayed on the second display layer. The message blocks displayed on the first display layer aim at providing a more convenient and visual message block display interface for the user; and the other message blocks displayed on the second display layer aim at emphasizing the message blocks on the first display layer.

Besides that the message blocks on the first display layer are displayed above the message blocks on the second display layer, in order to enhance the identification of the message blocks displayed on the first display layer, a mark attribute is further added to the message blocks displayed on the first display layer, i.e., the message blocks on the first display layer are marked differently from those on the second display layer, so as to enhance the visual effects of the message blocks on the first display layer. For example, all message blocks on the first display layer are displayed in a magnified way; or the edges of the message blocks on the first display layer are displayed with double lines, and the edges of the message blocks on the second display layer are not displayed with double lines.

Furthermore, in the present invention, linking information may be generated for each of the message blocks, which is generated when each of the message blocks is newly added and may be linked to the corresponding Email address according to the message identification information. For example, when the user wants to reply specific message contents to the message sender of the message identification information, the user may activate such linkage.

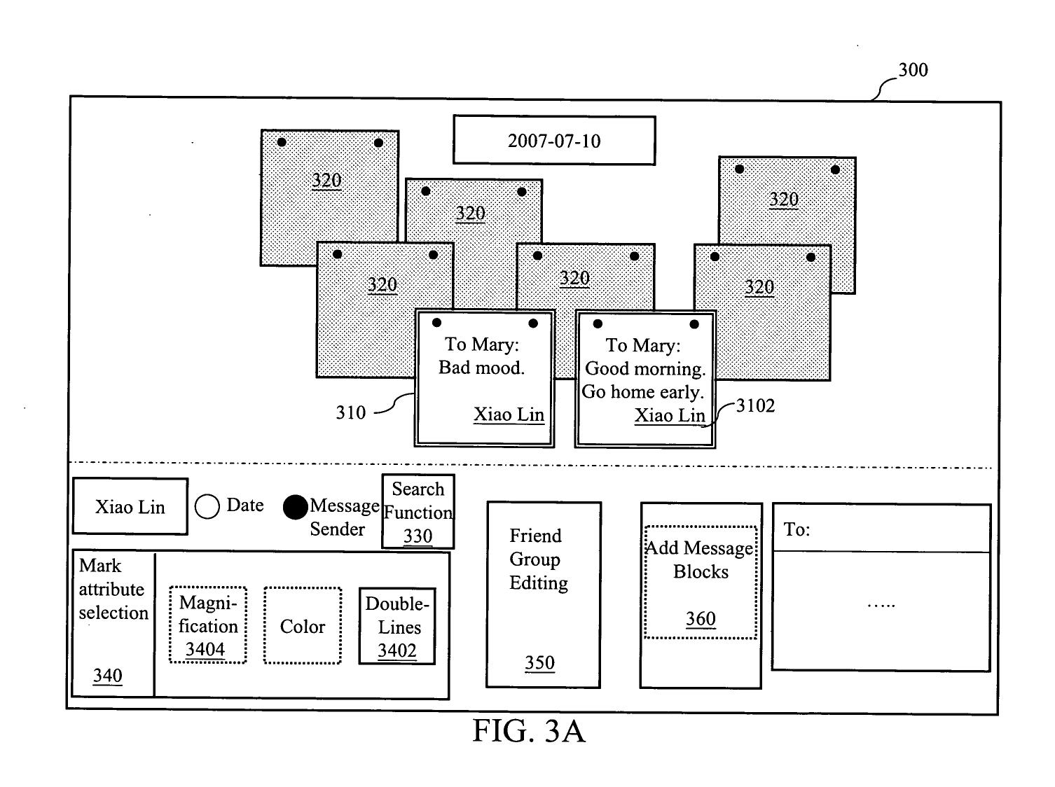

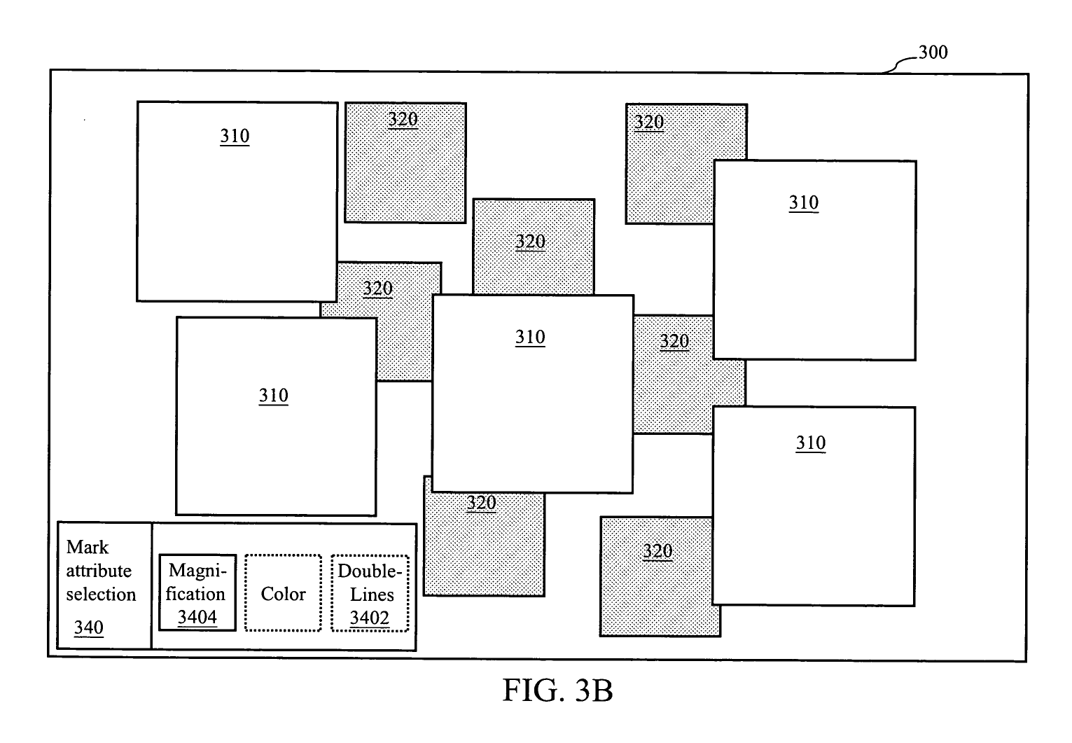

FIG. 3A is a schematic view of a message block display interface 300 according to a first embodiment of the present invention, which shows the message block display interface 300 appeared after the user inputs the operation identification information and the trigger event. Firstly, upon logging in the message website, the user inputs the user name (or the user code, or the user ID). The receiving module 210 receives the operation identification information (Step 110). In this embodiment, the user inputs the user code to log in the message website (such as an MSN message board). Although tens of message blocks have been added to the message block display interface 300 after the user logged out last time, the determination module 220 firstly determines whether the user code is consistent with one of the parameters of each of the message blocks (Step 120) once the user has logged in. If the user code is consistent with one of the parameters, the determination module 220 informs the message block adjustment module 230 and then the message blocks on the message block display interface 300 begin to move and the message blocks are displayed in different layers. Particularly, the message block adjustment module 230 moves the message blocks consistent with the operation identification information as the user code to the first display layer (Step 130), and all message blocks consistent with the user code are displayed on the first display layer and attached on the message block display interface 300 at random (not shown). The other message blocks inconsistent with the user code are displayed on the second display layer (Step 130).

Next, the user may use a search function block 330 on the message block display interface to search the desired message blocks to be read, i.e., a trigger event input by the user is received. In this embodiment, the message identification information input by the user is an ID of the message sender, i.e., the trigger event is “Xiao Lin”. Then, the determination module 220 determines whether the received trigger event “Xiao Lin” is consistent with one of the parameters of each of the message blocks (Step 150). If the received trigger event “Xiao Lin” is consistent with one of the parameters, the determination module 220 informs the message block adjustment module 230. At this time, the message blocks on the message block display interface 300 are displayed on different layers again. The message block adjustment module 230 moves the message blocks inconsistent with the trigger event “Xiao Lin” from the first display layer to the second display layer (Step 160), i.e., the message blocks on the second display layer 320 of the message block display interface in FIG. 3A, and meanwhile moves the message blocks consistent with the trigger event from the second display layer to the first display layer, i.e., the message blocks on the first display layer 310 of the message block display interface in FIG. 3A.

If the user still wants to use the searching function, he/she may input a trigger event once again (Step 140). Likewise, the determination module 220 determines whether the trigger event received once again is consistent with one of the parameters of each of the message blocks. Then, Steps 150 and 160 are repeated. In the present invention, the intersection search function may be further provided depend upon the user's requirements. For example, the user may input the time condition “Jul. 20, 2007” as the trigger event and the ID of the message sender “Xiao Lin” as the message identification information simultaneously, and the message blocks displayed on the first display layer are those (not shown) having the parameters be consistent with the time condition and the ID of the message sender.

In FIG. 3A, the message blocks on the first display layer are all displayed above those on the second display layer. It is mentioned above that all the message blocks on the first display layer have a mark attribute, i.e., all message blocks on the first display layer have one mark attribute different from that of the message blocks on the second display layer, and the user may select a mark attribute through using a mark attribute selection block 340. In this embodiment, the mark attribute is a double-line mark attribute 3402, which is displayed with double lines at the edges of the message blocks.

Meanwhile, the user may also give a selection instruction (i.e., the selection event of the trigger event) (not shown) to the message blocks through using a mouse. The selected message blocks are moved to the first display layer. In addition, there is a message block linking information 3102 below the ID of the message sender “Xiao Lin”, which is an Email address required to communicate with the ID of the message sender “Xiao Lin”. When the user wants to reply specific message content to the ID of the message sender “Xiao Lin”, he/she may activate such linkage.

The present invention may also provide the management functions for a common message website. The user may use the mouse to select the newly added message blocks 360 of the message block display interface, so as to input the message blocks, and may also use the mouse to select a friend group editing block 350 on the message block display interface to edit the friend group.

FIG. 3B is a schematic view of a message block display interface according to a second embodiment of the present invention. In this embodiment, when the user selects a magnification mark attribute 3404 in the mark attribute selection block 340 for magnification, i.e., when the operation identification information or the trigger event is consistent with one of the parameters of each of the message blocks, the message blocks are moved to the first display layer, and the message blocks inconsistent with the operation identification information or the trigger event are moved to the second display layer. In order to enhance the visual effects of the first display layer, when the user selects the magnification mark attribute 3404 in the mark attribute selection block 340 for magnification, the message blocks 310 on the first display layer of the message block display interface 300 are larger than the message blocks 320 on the second display layer, so as to display the message blocks required by the user on the message block display interface 300, thereby providing a visual interface suitable for the user. The magnification ratio should be determined depending upon actual requirements, which is not limited in the present invention. Meanwhile, any mark attribute capable of enhancing the visual effect of the first display layer does not depart from the spirit and scope of the present invention.

The present invention determines the operation identification information and the trigger event, moves the message blocks consistent with the operation identification information and the trigger event to the first display layer, moves the inconsistent message blocks to the second display layer, and utilizes the mark attribute to highlight the message blocks, so that the user may feel the convenience of operation and the display visualization effect, thereby achieving a movable message block display interface demanded by the user for displaying the message blocks.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for displaying movable message blocks, applied in a message block display interface having a plurality of message blocks, comprising:
receiving operation identification information;
when determining that the operation identification information is consistent with one of a plurality of parameters of each of the message blocks, further comprising:
moving the message block consistent with the operation identification information to a first display layer; and
moving the message block inconsistent with the operation identification information to a second display layer; and
waiting for receiving at least one trigger event, and when determining that trigger event is consistent with one of the parameters of each of the message blocks, further comprising:
moving the message block inconsistent with the trigger event from the first display layer to the second display layer; and
move the message block consistent with the trigger event from the second display layer to the first display layer;
wherein the first display layer is displayed above the second display layer.

2. The method for displaying movable message blocks as claimed in claim 1, wherein the trigger event comprises input information and a selection event, wherein the input information is an input time condition or input message identification information and the selection event is a selection instruction.

3. The method for displaying movable message blocks as claimed in claim 2, wherein the parameters comprise the operation identification information, the time condition, the message identification information, and the selection instruction.

4. The method for displaying movable message blocks as claimed in claim 1, wherein the message block displayed on the first display layer further has a mark attribute for controlling a display color, a display size, or a display stroke of the message block.

5. The method for displaying movable message blocks as claimed in claim 1, wherein each of the message blocks further comprises linking information, and the linking information is an Email address.

6. A system for displaying movable message blocks, applied in a message block display interface having a plurality of message blocks, comprising:
a receiving module, for receiving operation identification information and waiting for receiving at least one trigger event;
a determination module, for determining whether the operation identification information is consistent with one of a plurality of parameters of each of the message blocks, and for determining whether the trigger event is consistent with one of the parameters of each of the message blocks; and
a message block adjustment module, for moving the message block consistent with the operation identification information to a first display layer and moving the message block inconsistent with operation identification information to a second display layer, when the determination module determines that the operation identification information is consistent with one of the parameters of each of the message blocks; and moving the message block inconsistent with the trigger event from the first display layer to the second display layer and moving the message block consistent with the trigger event from the second display layer to the first display layer, when the trigger event is received and the determination module determines that the trigger event is consistent with one of the parameters of each of the message blocks;
wherein the first display layer is displayed above the second display layer.

7. The system for displaying movable message blocks as claimed in claim 6, wherein the trigger event comprises input information and a selection event, and the input information is an input time condition or input message identification information and the selection event is a selection instruction.

8. The system for displaying movable message blocks as claimed in claim 7, wherein the parameters comprise the operation identification information, the time condition, the message identification information, and the selection instruction.

9. The system for displaying movable message blocks as claimed in claim 6, wherein the message block displayed on the first display layer further has a mark attribute for controlling a display color, a display size, or a display stroke of the message block.

10. The system for displaying movable message blocks as claimed in claim 6, wherein each of the message blocks further comprises linking information, and the linking information is an Email address.
